(19) United States
(12) Patent Application Publication
(10) Pub. No.: US 2025/0237289 A1
(43) Pub. Date: Jul. 24, 2025

(54) CENTRIFUGAL FORCE PENDULUM COMPRISING RADIALLY INTERNAL STOP DAMPER

(71) Applicant: Schaeffler Technologies AG & Co. KG, Herzogenaurach (DE)

(72) Inventor: Evgenij Franz, Rastatt (DE)

(73) Assignee: Schaeffler Technologies AG & Co. KG, Herzogenaurach (DE)

(21) Appl. No.: 18/704,454

(22) PCT Filed: Nov. 10, 2022
(86) PCT No.: PCT/DE2022/100834

§ 371 Date: Apr. 25, 2024

(30) Foreign Application Priority Data
Nov. 26, 2021 (DE) 10 2021 131 102.0

(51) Int. Cl. F16F 15/14; F16D 3/12; F16D 3/66

(52) U.S. Cl. CPC F16F 15/145; F16D 3/12; F16D 3/66; F16D 2300/22; F16F 2222/04; F16F 2222/08; F16F 2224/025; F16F 2230/0005; F16F 2230/007; F16F 2230/36; F16F 2232/02; F16F 2236/08

(57) ABSTRACT

A centrifugal force pendulum includes two pendulum flanges, a pendulum mass, a stop damper and roller bodies. The two pendulum flanges are rotationally fixed together, include respective flange cutouts, and define a pendulum mass receiving space therebetween. The pendulum mass is arranged in the pendulum mass receiving space and includes a mass cutout and a radial inner face. The stop damper is arranged on the radial inner face and includes two through-openings. The roller bodies extend through the flange cutouts and the mass cutout. The flange cutouts and the mass cutout define a movement path, the pendulum mass is movable relative to the two pendulum flanges along the movement path, and fastening elements extend through the two through-openings to connect the stop damper to the pendulum mass. A torsional vibration damper including the centrifugal force pendulum is also disclosed.

### CROSS-REFERENCE TO RELATED APPLICATIONS

This application is the United States National Phase of PCT Appln. No. PCT/DE2022/100834 filed Nov. 10, 2022, which claims priority to German Application No. DE102021131102.0 filed Nov. 26, 2021, the entire disclosures of which are incorporated by reference herein.

### TECHNICAL FIELD

The present disclosure relates to a centrifugal force pendulum comprising a radially internal stop damper. The centrifugal force pendulum according to the disclosure may be used in the drive train of motor vehicles to damp or cancel torsional vibrations.

### BACKGROUND

Centrifugal force pendulums for use in drive trains of motor vehicles are known. They serve to damp vibrations in the drive train and are often used in conjunction with torsional vibration dampers. Centrifugal force pendulums have at least one pendulum flange and pendulum masses that can be moved relative to the pendulum flange on predetermined movement paths under centrifugal force. Design of the pendulum masses and the movement paths can ensure that certain torsional vibration frequencies in the drive train are damped. If a pendulum mass reaches one end of the movement path, it strikes against the end of the movement path. This creates noise in the drive train, and the end of the movement path becomes stressed and possibly worn.

Stop dampers are known to reduce this problem. For example, DE 10 2015 212 737 A1 discloses a stop damper which is designed as an elastomeric ball which is arranged in a radially inner recess of the pendulum mass. The size of the ball is limited by the thickness of the pendulum mass. Particularly with relatively heavy pendulum masses, the damping achievable therewith may be no longer sufficient.

### SUMMARY

The centrifugal force pendulum according to the disclosure includes two pendulum flanges which are rotationally fixed to one another, are rotatable about an axis of rotation and define a pendulum mass receiving space between the pendulum flanges in the direction of the axis of rotation. The pendulum also includes at least one pendulum mass arranged in the pendulum mass receiving space which is movable relative to the pendulum flanges on at least one movement path which is defined by cutouts in the pendulum flanges and the pendulum mass. Roller bodies extend through the cutouts, and a stop damper is formed on each pendulum mass. The stop damper is arranged on a radial inner face of the pendulum mass and has at least two through-openings into or even through which extend fastening elements which connect the stop damper to the pendulum mass.

The centrifugal force pendulum may be used in the drive train of motor vehicles that have an internal combustion engine as a torque source. In addition, the drive train can also have one or a plurality of electric motors as a torque source. The centrifugal force pendulum damps or cancels certain vibration frequencies of torsional vibrations in the drive train. The stop damper prevents the pendulum mass from striking against the pendulum flanges and causing noise and/or wear on the pendulum flange and/or pendulum mass. Due to the arrangement of the stop damper on the radial inner face of the pendulum mass and its connection to the pendulum mass by fastening elements that extend into or through the through-openings, a damping effect can be achieved that is independent of the thickness of the pendulum mass, i.e. its extent in the direction of the axis of rotation.

The stop damper strikes against another component, e.g., a contact portion of one of the pendulum flanges. The stop damper can easily be mounted, e.g., pre-mounted, on the pendulum mass such that the pendulum mass can then be mounted with the stop damper mounted. The pendulum mass may have a mounting cutout on the radial inner face, relative to the axis of rotation, which is designed to correspond to the contour of the stop damper.

The fastening elements may include pin connections. These are formed by pins that are oversized compared to the through-openings, such that a force- and form-fit connection is formed between the pin and the through-opening.

The fastening elements may form a snap-fit connection when there are two fastening elements which engage in the through-opening from both sides and form a snap-fit connection with one another. In this case, each fastening element may have a snap-fit hook.

Each pendulum mass may have at least one friction element which is formed on one side of the pendulum mass in the direction of the axis of rotation and rests on the pendulum mass. Friction elements may be made of an elastomeric plastic, for example, and regularly interact with corresponding friction elements on one of the pendulum flanges in order to bring about braking of the pendulum mass relative to the pendulum flange. Furthermore, an example embodiment provides that two friction elements are formed, which are formed on opposite sides of the pendulum mass with respect to the axis of rotation.

Each friction element may have snap-fit elements as fastening elements which extend into or through the through-openings of the stop damper. If two friction elements are formed on opposite sides of the pendulum flange, the snap-fit elements of the two friction elements may work together to form a snap-fit connection in the respective through-opening. This enables easy mounting of the stop damper and the friction elements.

The snap-fit element may be formed in one piece with the friction element. This enables easy mounting of the stop damper. The friction element can, for example, be easily produced with the snap-fit element made of a plastic using an injection molding process.

Each friction element may have at least two pins which engage in corresponding cutouts in the pendulum mass. This allows pin connections to be formed to fix the friction element to the pendulum mass. The pin may be oversized in a plane perpendicular to the axis of rotation compared to the corresponding cutout in the pendulum mass.

The stop damper may be formed at least in part from an elastomeric material. For example, a damping portion of the stop damper or alternatively the entire stop damper may be made of an elastomer.

Furthermore, a torsional vibration damper is proposed, having an input part, an output part and a spring device. The input part and the output part are rotatable relative to one another about an axis of rotation against the action of the spring device, and the input part and/or the output part are connected in a rotationally fixed manner to a centrifugal force pendulum according to the present disclosure.

The input part may be directly or indirectly connected or connectable to an internal combustion engine, for example via a friction clutch for coupling and uncoupling the internal combustion engine to/from the drive train. The output part may be connected to the centrifugal force pendulum in a rotationally fixed manner. The torsional vibration damper may have a slip clutch on the radial inner face as a torque limiter.

As a precaution, it should be noted that the numerical designations used here (“first”, “second”, etc.) serve primarily (only) to distinguish between a number of similar objects, sizes, or processes, and in particular do not necessarily specify a dependency and/or sequence of these objects, sizes, or processes to one another. Should a dependency and/or sequence be necessary, this is explicitly stated here or results in a manner obvious to a person skilled in the art when studying the specifically described embodiment.

### BRIEF DESCRIPTION OF THE DRAWINGS

Both the invention and the technical field are explained in more detail below with reference to the figures. It should be noted that the disclosure is not intended to be limited by the exemplary embodiments shown. In particular, unless explicitly stated otherwise, it is also possible to extract sub-aspects of the subject matter explained in the figures and to combine them with other components and knowledge from the present description and/or figures. In particular, it should be noted that the figures and in particular the proportions shown are only schematic in nature. Identical reference symbols indicate the same objects, such that, where applicable, explanations from other figures can also be used. In the figures:

FIG. 1 shows a cross-section through a torsional vibration damper with an example of a centrifugal force pendulum;

FIG. 2 shows a top view of a centrifugal force pendulum;

FIGS. 3 to 5 show various sections through a pendulum mass of a centrifugal force pendulum with friction elements;

FIG. 6 shows a perspective view of a friction element;

FIGS. 7 to 8 show two views of a stop damper;

FIG. 9 shows an exploded view of a pendulum mass with friction elements and stop damper; and

FIG. 10 shows a perspective view of a pendulum mass with mounted friction elements and stop dampers.

### DETAILED DESCRIPTION

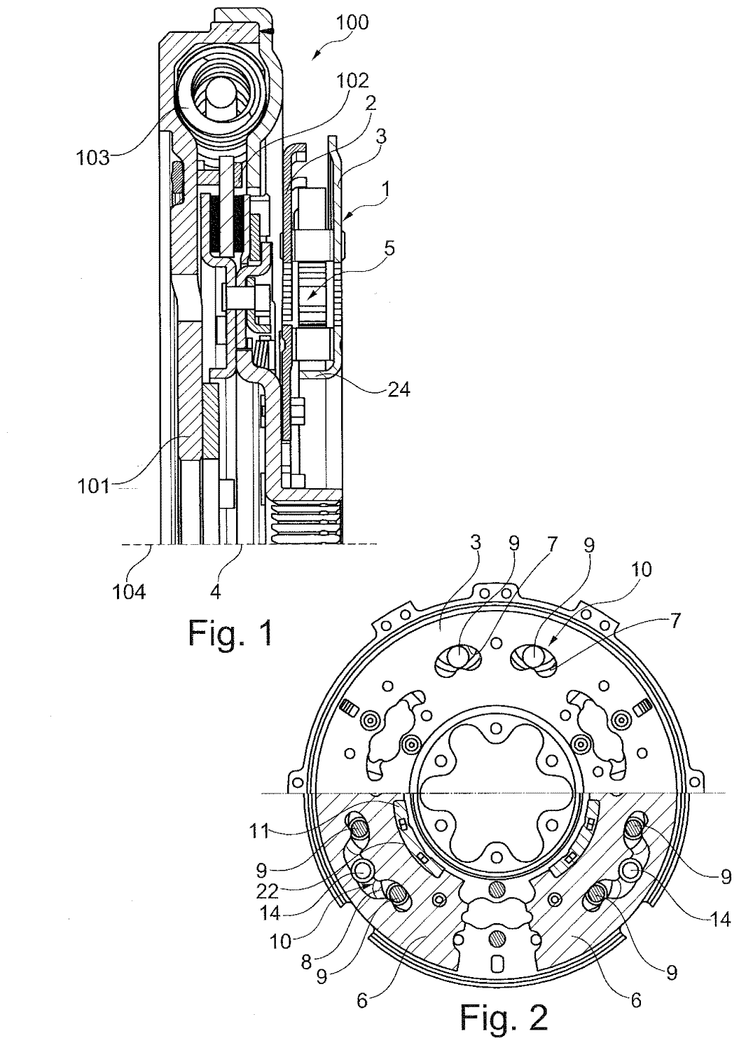

FIG. 1 shows a torsional vibration damper 100 in cross-section. The torsional vibration damper 100 includes an input part 101 and an output part 102. The input part 101 and output part 102 can be rotated relative to one another about an axis of rotation 104 against the action of a spring device 103. The input part may be directly or indirectly connected to an output shaft, not shown, of an internal combustion engine, not shown. A direct connection can be made, for example, by connecting the input part 101 in a rotationally fixed manner to the crankshaft or a flywheel of the internal combustion engine. An indirect connection can be achieved by forming at least one further element, such as a friction clutch, between the internal combustion engine and the torsional vibration damper 100.

A centrifugal force pendulum 1 is connected in a rotationally fixed manner to the output part 102 of the torsional vibration damper 100. The centrifugal force pendulum 1 includes a first pendulum flange 2 and a second pendulum flange 3, which can rotate about an axis of rotation 4, which corresponds to the axis of rotation 104. The first pendulum flange 2 and the second pendulum flange 3 are connected to one another in a rotationally fixed manner and define a pendulum mass receiving space 5 in the direction of the axis of rotation 4 between the first pendulum flange 2 and the second pendulum flange 3.

FIG. 2 shows a top view of the centrifugal force pendulum 1 from FIG. 1, the viewing direction being from the right in FIG. 1. FIG. 2 shows only part of the second pendulum flange 3, such that the pendulum masses 6 lying in the direction of the axis of rotation 4 between the first pendulum flange 2 and the second pendulum flange 3. Overall, this example of a centrifugal force pendulum 1 has three pendulum masses 6, which are evenly distributed over the circumference—relative to the axis of rotation 4—and lie in a common plane that is normal to the axis of rotation 4. The second pendulum flange 3 as well as the first pendulum flange 2 have cutouts 7, while each pendulum mass 6 has cutouts 8. Roller bodies 9 are formed in the cutouts 7, 8, which roller bodies enable movement of the pendulum masses 6 relative to the first pendulum flange 2 and the second pendulum flange 3 to damp certain frequencies. The roller bodies 9 move in the cutouts 7, 8, which form movement paths 10, which are defined in such a way that they enable the desired centrifugal force-induced pendulum movement of the pendulum masses 6 relative to the pendulum flanges 2, 3.

On the radial inner face, each pendulum mass 6 has a stop damper 11. The pendulum mass 6, stop damper 11 and second pendulum flange 3 are designed in such a way that, at maximum deflection of the pendulum mass 6, the stop damper 11 damps the movement of the pendulum mass 6. The configuration on the radial inner face means that, in a non-deflected state as shown in FIG. 2, relative to the axis of rotation 4, the stop dampers 11 project radially inwardly beyond the pendulum mass 6, such that contact can occur on the radial inner face only with the stop damper 11, but not with the pendulum mass 6. The stop damper 11 may be made of an elastomeric material.

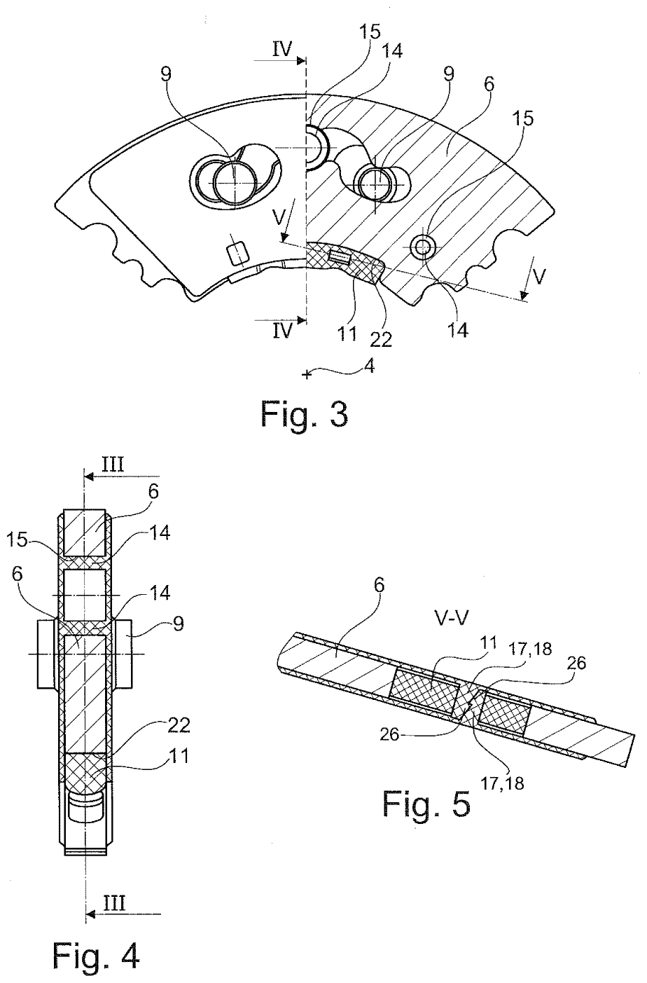

The stop damper 11 and an example of the mounting thereof on the pendulum mass 6 are described below with particular reference to FIGS. 3 to 8. Unless explicitly stated otherwise, these figures are described together below. FIGS. 3 to 6 show various sections through the pendulum mass 6. FIG. 3 shows the section denoted “III-III” in FIG. 4, FIG. 4 shows the section denoted “IV-IV” in FIG. 3 and FIG. 5 shows the section denoted “V-V” in FIG. 3.

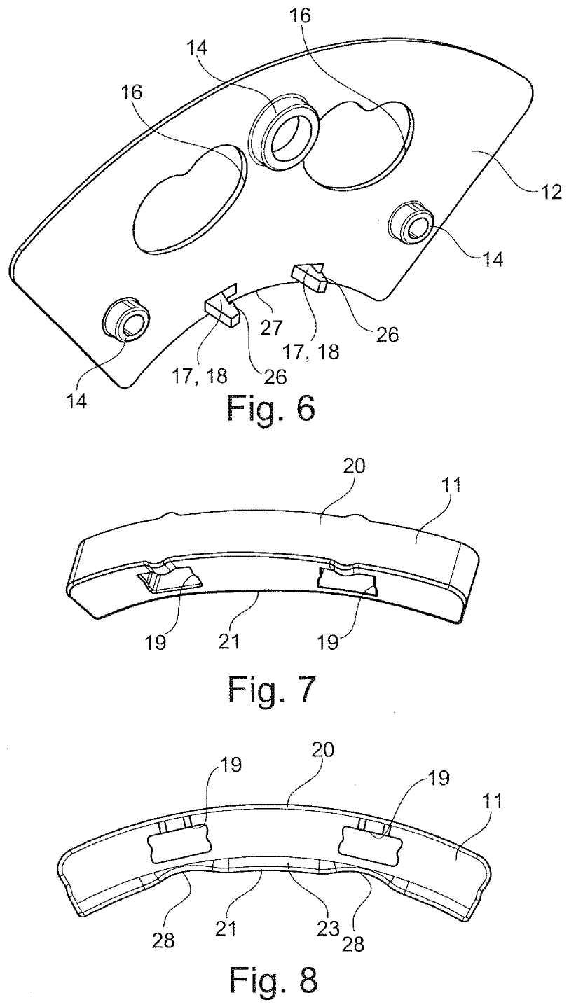

In this example, the pendulum mass 6 is provided with two friction elements 12, which rest on the longitudinal sides 13 of the pendulum mass that are opposite in the direction of the axis of rotation 4. A friction element 12 is shown in a perspective view in FIG. 6. The friction element 12 has pins 14, in this example three pins 14. The friction element 12 is connected to a pendulum mass 6 via the pins 14, which are pressed into corresponding cutouts 15 in the pendulum mass 6, thus forming a form- and force-fit connection between the friction element 12 and the pendulum mass 6. The pins 14 are appropriately oversized relative to the corresponding cutouts 15. The friction element 12 also has cutouts 16 which correspond to the cutouts 8 of the pendulum mass to form the movement path 10.

Furthermore, the friction element 12 has two fastening elements 17 on a radial inner face 27. These are designed as snap-fit elements 18 with corresponding snap-fit hooks 26. The stop damper 11 (see in particular FIGS. 7 and 8) has two through-openings 19, the position and spacing of which are selected such that, when the friction element 12 is mounted with the stop damper 11 on the pendulum mass 6, the fastening means 17 engage through the through-openings 19. In the present example (see in particular FIG. 5), two friction elements 11 are formed per pendulum mass 6, such that during assembly the snap-fit hooks 18 of the two friction elements 11 extend through the through-openings 19 of the stop damper 11 and form a snap-fit connection.

When installed, the stop damper 11 has a convex outer surface 20 and an inner surface 21 in the radial direction relative to the axis of rotation 4. The outer surface 20 corresponds to a mounting cutout 22 of the pendulum mass 6 (see in particular FIG. 3). The inner surface 21 has a damping portion 23, which brings about the damping function, in particular in contact with a contact portion 24 of the second pendulum flange 3 (see FIG. 1). The damping portion 23 has two depressions 28, the position of which corresponds to the position of the through-openings 19. This ensures that, on impact of the impact damper 11, the force introduced into the area of the through-openings 19 and thus into the area of the fastening elements 17 formed there is reduced, such that the fastening elements 17 are protected during operation.

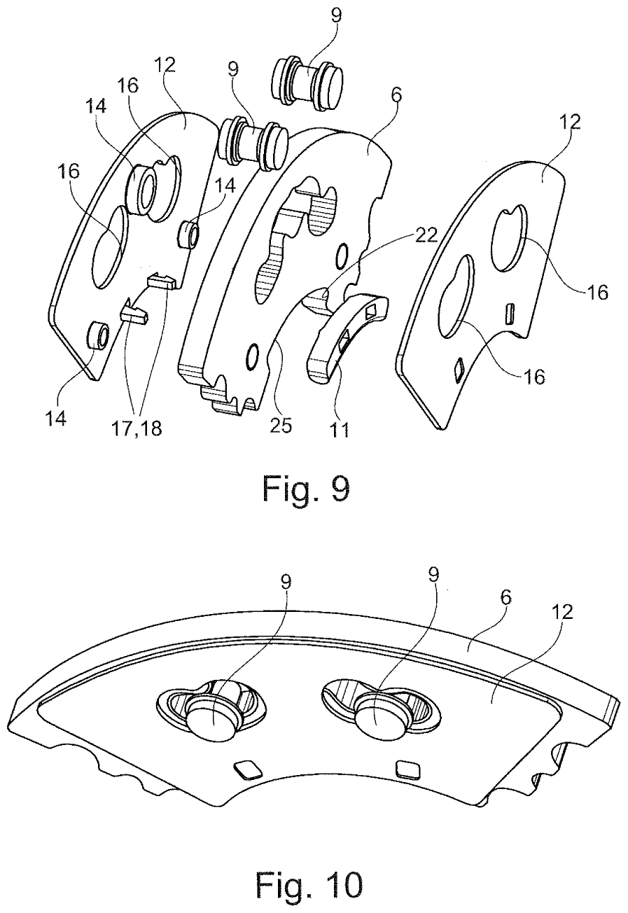

FIG. 9 shows an exploded view of a pendulum mass 6 with friction elements 12, stop dampers 11 and roller bodies 9. The radial inner face 25, on which the mounting cutout 22 is formed, is shown on the pendulum mass 6. FIG. 10 shows a perspective view of the pendulum mass 6 with mounted friction elements 12 and roller bodies 9.

The centrifugal force pendulum 1 has a stop damper 11 on its radial inner face 25, by way of which the stopping processes of the pendulum mass 6 on one of the pendulum flanges 2, 3 are damped. The stop damper 11 has two through-openings 19 into or through which extend fastening elements 17, 8. This makes the stop damper 11 easy to mount and to pre-mount on the pendulum mass 6. If the pendulum mass 6 has one or two friction elements 12 at the same time, the stop damper 11 can be fixed to the pendulum mass by fastening elements 17, 18 which are formed on the friction element 12.

### REFERENCE NUMERALS

1 Centrifugal force pendulum
2 First pendulum flange
3 Second pendulum flange
4 Axis of rotation
5 Pendulum mass receiving space
6 Pendulum mass
7 Cutout
8 Cutout
9 Roller body
10 Movement path
11 Stop damper
12 Friction element
13 Longitudinal side
14 Pin
15 Cutout
16 Radial inner face
17 Fastening element
18 Snap-fit hook
19 Through-opening
20 Outer surface
21 Inner surface
22 Assembly cutout
23 Damping portion
24 Contact portion
25 Radial inner face
26 Snap-fit hook
27 Radial inner face
28 Depression
100 Torsional vibration damper
101 Input part
102 Output part
103 Spring device
104 Axis of rotation

1. A centrifugal force pendulum, comprising two pendulum flanges which are rotationally fixed to one another, are rotatable about an axis of rotation and define a pendulum mass receiving space between the pendulum flanges in a direction of the axis of rotation, and at least one pendulum mass arranged in the pendulum mass receiving space which is movable relative to the pendulum flanges on at least one movement path which is defined by cutouts in the pendulum flanges and the pendulum mass, wherein roller bodies extend through the cutouts, wherein a stop damper is formed on each pendulum mass, wherein the stop damper is arranged on a radial inner face of the pendulum mass and has at least two through-openings into which extend fastening elements which connect the stop damper to the pendulum mass.

2. The centrifugal force pendulum according to claim 1, in which the fastening elements comprise pin connections.

3. The centrifugal force pendulum according to claim 1, in which the fastening elements form a snap-fit connection.

4. The centrifugal force pendulum according to claim 1, in which each pendulum mass has at least one friction element which is formed on one side of the pendulum mass in the direction of the axis of rotation and rests on the pendulum mass.

5. The centrifugal force pendulum according to claim 4, in which the at least one friction element has snap-fit elements as the fastening elements which extend into the through-openings of the stop damper.

6. The centrifugal force pendulum according to claim 5, in which each snap-fit element is formed in one piece with the respective friction element.

7. The centrifugal force pendulum according to claim 4, in which each friction element has at least two pins which engage in corresponding cutouts in the pendulum mass.

8. The centrifugal force pendulum according to claim 1, in which the stop damper is formed at least in part from an elastomeric material.

9. A torsional vibration damper comprising an input part, an output part and a spring device, wherein the input part and the output part are rotatable relative to one another about an axis of rotation against the action of the spring device, wherein the input part or the output part is connected in a rotationally fixed manner to the centrifugal force pendulum according to claim 1.

10. A centrifugal force pendulum, comprising:
two pendulum flanges that:
are rotationally fixed together;
comprise respective flange cutouts; and
define a pendulum mass receiving space therebetween;
a pendulum mass arranged in the pendulum mass receiving space, the pendulum mass comprising:
a mass cutout; and
a radial inner face;
a stop damper arranged on the radial inner face, the stop damper comprising two through-openings; and
roller bodies extending through the flange cutouts and the mass cutout, wherein:
the flange cutouts and the mass cutout define a movement path;
the pendulum mass is movable relative to the two pendulum flanges along the movement path; and
fastening elements extend through the two through-openings to connect the stop damper to the pendulum mass.

11. The centrifugal force pendulum of claim 10, wherein the fastening elements comprise pin connections.

12. The centrifugal force pendulum of claim 10, wherein the fastening elements form a snap-fit connection.

13. The centrifugal force pendulum of claim 10, further comprising a friction element formed on an axial side of the pendulum mass and resting on the pendulum mass.

14. The centrifugal force pendulum of claim 13, wherein:
the friction element comprises snap-fit elements; and
the snap-fit elements are the fastening elements.

15. The centrifugal force pendulum of claim 14 wherein the snap-fit elements are formed in one piece with the friction element.

16. The centrifugal force pendulum of claim 13 wherein:
the pendulum mass further comprises two pin cutouts; and
the friction element comprises two pins, each engaged in a respective one of the two pin cutouts.

17. The centrifugal force pendulum of claim 10, wherein the stop damper is formed from an elastomeric material.
